(19) United States
(12) Patent Application Publication
(10) Pub. No.: US 2026/0217324 A1
(43) Pub. Date: Jul. 30, 2026

(54) TRACK AND TRACKED VEHICLE COMPRISING SUCH TRACK

(71) Applicants: Berco S.p.A., Copparo/Ferrara (IT); thyssenkrupp AG, Essen (DE)

(72) Inventors: Francesco GRENZI, Ferrara (IT); Raffaele DE SCISCIOLO, Santa Paolina AV (IT)

(73) Assignees: Berco S.p.A., Copparo/Ferrara (IT); thyssenkrupp AG, Essen (DE)

(21) Appl. No.: 19/141,855

(22) PCT Filed: Dec. 21, 2023
(86) PCT No.: PCT/EP2023/087365

§ 371 Date: Jun. 20, 2025

(30) Foreign Application Priority Data
Dec. 22, 2022 (IT) 102022000026448

(51) Int. Cl. B62D 55/21

(52) U.S. Cl. CPC B62D 55/21

(57) ABSTRACT

A track comprises track modules making up a track chain. Each track module comprises a first and a second track link and a plurality of pin assemblies. Each pin assembly comprises a hinging pin and a main pin bushing. Each hinging pin terminates in two coupling pin ends. Each coupling pin end of said hinging pins fits in a respective pin coupling seat of a track link of an adjacent track module. Each coupling pin end is delimited by a shoulder resting or however arranged for resting against a respective track link of an adjacent track module so as to prevent or limit the axial displacement of said hinging pins relative to the track links of the adjacent track module.

### FIELD OF THE INVENTION

The present invention relates to a track for a tracked vehicle such as crawlers, tanks, bulldozers, and other earthmoving machines and heavy equipment.

The present invention relates in particular to an arrangement for avoiding or reducing to a negligible extent the so-called “pin walking”.

### BACKGROUND ART

Articulated endless tracks 1′ of vehicles such as tractors, bulldozers or other earthmoving machines and heavy equipment or tanks generally comprise a plurality of track modules 2′, each of which in turn comprises a first and a second track link 3′ arranged side by side one another and a plurality of pin assemblies 9′ connecting the first to the second track link 3′ (FIGS. 1, 2).

Each pin assembly 9′ comprises a hinging pin 90′ and a main pin bushing 92′.

This is done by press-fitting the two opposite ends of each hinging pin 90′ in two pin bores 300′ made in the ends of the track links 3′ of an adjacent track module 2′, so as to prevent it from rotating relative to the track links 3′; this way each hinging pin 90′ connects transversally the two track links 3′ of a track module.

Each end of the main pin bushing 92′ is press-fitted in the bushing bore 310′ of two ends of two respective track links 3′ of the track module 2′ of which the pin assembly 9′ is part.

Since the hinging pin 90′ axially extends through and beyond its respective main pin bushing 92′ and is able to rotate relative to the bushing 92′, each pin assembly 9′ connects and articulates two adjacent track modules.

In some applications of endless track chains in earth moving machines, mining, heavy constructions, demolition, waste disposal and forestry, the coupling of the hinging pins 90′ between two facing track links 3′ looses structural integrity and the pin 90′ displaces axially within the track link bores 300′.

This phenomenon called in the current technical jargon “pin walking” can be very critical for the mechanical integrity of the track 1′ and in some cases causes its premature failure.

Until it does not cause the pin 90′ to come completely out of one of the bores 300′, this axial displacement reduces the contact surface of the pin end in the bore 300′, concentrating the pressure on the smaller surface, increasing the wear of the pin end and of the bore surface and shortening the operating life of the track 1′ (FIG. 1).

When in extreme cases the pin 90′ completely comes out of the bore 300′, it is stressed like a cantilever by the track links 3′ which it is still engaged with (FIG. 2) causing the rapid ripping of the whole track 1′.

A first known solution for avoiding or limiting pin walking is shown in FIG. 7: an elastic snap ring 91 is assembled at the ends of the hinging pin 90′ just out of their respective bores 300′; in case of pin walking the snap ring 91 rests against the outer side of the track link 3′ keeping the axial displacement of the pin 90′ negligible.

The authors of the present invention noted that a first drawback of this arrangement is that two elastic snap ring 91 are added to each track module; furthermore two annular grooves need to be made in each pin 90′ for receiving the two snap rings 91; such annular grooves need to be made through a special turning tool different from that to be used for turning the sides of the pin 90′; in other words this arrangement needs many parts to be added and all pins 90 of a track undergo an additional machining step, with non negligible additional costs.

Furthermore during operation the snap rings 90 can touch and be worn out by the flanges of the idle rolls on or under which the endless track runs until they are torn off or however broken.

A second known solution for avoiding or limiting pin walking is a pin-retention system manufactured by the applicants, commercially called BPR2 (registered trademark) and shown in FIG. 8: a metal ring 93 is plastically deformed and fit around the ends of the hinging pin 90′.

The metal ring 93 is pressed in a circular slot 95 formed partly in the hinging pin 90′ and partly in the bore 300′ made in the track link 3′, blocking the joint to specific predetermined end-play levels.

In this second arrangement the metal ring is less subject to wear caused by the rolls compared to the first known solution, but it still has the other shortcomings as of the snap ring 91, that is the need of a great number of additional parts and special manufacturing steps.

An objective of the present invention is remedying to the shortcomings of the prior art, providing an endless track for vehicles which is not subject, or however less subject, to pin walking.

### SUMMARY OF THE INVENTION

According to a first aspect of the present invention this object is achieved through a track having the features according to the preamble of claim 1, characterised in that each coupling pin end is delimited by a shoulder resting or however arranged for resting against a respective track link of an adjacent track module so as to prevent or limit the axial displacement of said hinging pins relative to the track links of the adjacent track module.

The shoulder is able to stop very soon the pin-walking; it just negligibly reduces the contact surface of the two coupling pin ends with their respective pin coupling seats without compromising the operation, resistance and operating life of the track.

The shoulder allows the track to be kept operating correctly still for a relatively long time until the disconnection of the pin from the seats is detected and repaired.

The shoulders have a very simple construction, are very easy to manufacture (without the need for changing the turning tool and carrying out separate manufacturing step) and are able to withstand very strong axial thrusts.

Unlike the known arrangements of FIGS. 7, 8 the shoulders add very limited costs to the manufacturing process: for example they can be obtained through simple turning with the same tool used for turning the sides of the pins; they do not need to be made with a special turning tool; nor do they require additional parts to be assembled in the endless track.

Furthermore reducing or avoiding pin walking through the shoulder is in no way affected by wear of the endless track against the rolls.

The shoulder allows the axial displacement of the pin be reliably kept equal or smaller than the width of the shoulder in case of pin walking, for example equal to or less than 0.1-1 millimetres.

These advantages are particularly appreciable in heavy duty applications such as in mining, heavy constructions, demolition and waste disposal, and in general in earthmoving machines, heavy equipment and forestry.

According to a second aspect of the present invention this object is achieved through a tracked vehicle having the features according to the first aspect of the invention.

Such tracked vehicle is more reliable and less subject to failures thanks to the advantages of the shoulder.

In a particular embodiment of a track according to the invention, said shoulder has a radial width comprised between 0.1-1 millimetres.

In a particular embodiment of a track according to the invention, said shoulder has a radial width comprised between 0.3-0.8 millimetres.

Such small widths contribute to keep the additional manufacturing costs low and simplify the manufacturing process.

In a particular embodiment of a track according to the invention, the edge of the pin coupling seat, against which the shoulder can rest, is substantially not chamfered or has a circumferential chamfer the radial width or axial depth of which is advantageously equal to or smaller than the radial width of the shoulder.

A substantially absent or small chamfer reduces the displacement of the pin due to pin-walking.

In a particular embodiment of a track according to the invention, the pin coupling seat, against which the shoulder can rest, has a substantially rounded or smooth edge, and the average or maximum radius of curvature of the axial cross sections of said edge is advantageously equal to or smaller than the radial width of the shoulder.

Also a substantially small radius of curvature of the axial cross sections of said edge helps to reduce the displacement of the pin due to pin-walking.

In a particular embodiment of a track according to the invention, each of said hinging pins forms an enlarged central section arranged, with reference to the axis of the hinging pin, between said two coupling pin ends, each of said shoulder is axially interposed between a respective coupling pin end and the enlarged central section, the enlarged central section has an average or maximum diameter substantially greater than the average or maximum diameter, respectively, of the coupling pin ends of the same hinging pin.

In a particular embodiment of a track according to the invention, the average or maximum diameter of the enlarged central section and/or of the coupling pin ends is comprised between 20-200 millimetres or 30-150 millimetres.

In a particular embodiment of a track according to the invention, one or more of said hinging pins have an overall axial length comprised between 80-800 millimetres or 100-600 millimetres.

In a particular embodiment of a track according to the invention, each coupling pin end of said hinging pins is press-fitted, drive-fitted or forced-fitted in a respective pin coupling seat of a track link (3) of an adjacent track module (2).

In a particular embodiment of a track according to the invention, each of said hinging pins forms an enlarged central section arranged axially between said two coupling pin ends.

In a particular embodiment of a track according to the invention, one or both coupling pin ends and/or the enlarged central section of the hinging pin has a substantially cylindrical shape.

The advantages which can be achieved through the present invention will appear more evident to the skilled person, from the following detailed description of a particular and non-limiting embodiment, described with reference to the following schematic figures.

### LIST OF FIGURES

FIG. 1 shows a front view, partially sectioned, of a longitudinal section of a known endless track affected by pin walking;

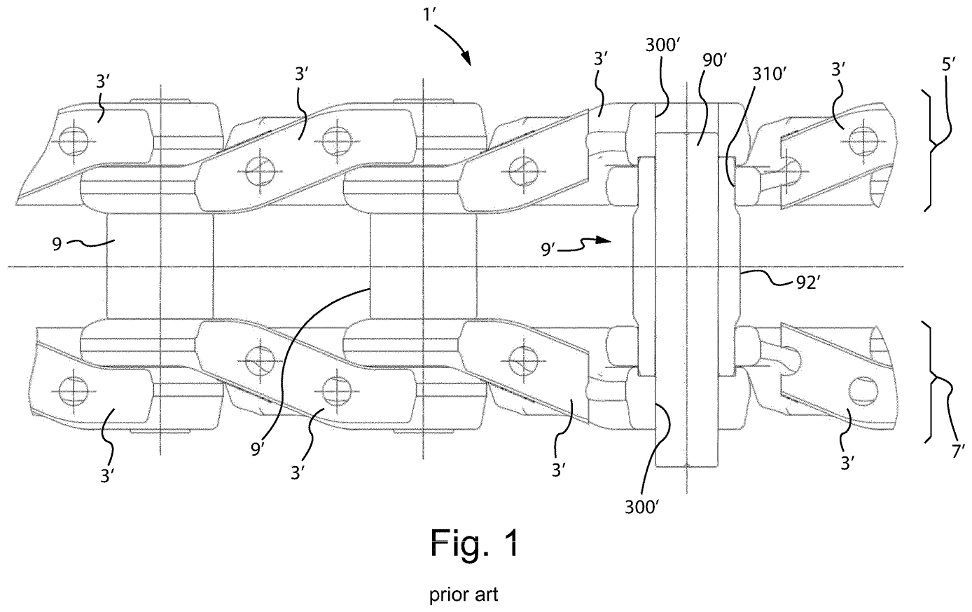

FIG. 2 shows a front view, partially sectioned, of the longitudinal section of the known endless track of FIG. 1, affected by a more severe pin walking;

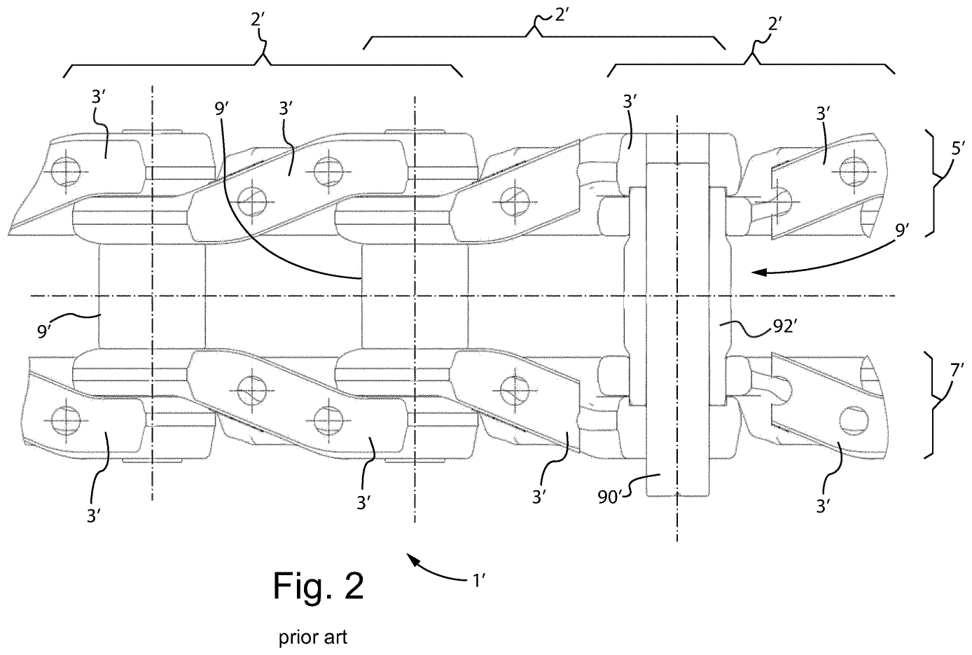

FIG. 3 shows a front view, partially sectioned, of a longitudinal section of an endless track according to a particular embodiment of the present invention;

FIG. 3A shows an enlarged view of a detail of the endless track of FIG. 3;

FIG. 3B shows an enlarged view of a detail of the endless track of FIG. 3A;

FIG. 3C shows an enlarged view of a detail of FIG. 3B;

FIG. 4 shows a side view of a track link, observed in a direction parallel to the rotation axes of the hinging pins;

FIG. 5 shows a cross section of a main pin bushing of the track of FIG. 3, in an ideal plane crossing the longitudinal axis of the bushing;

FIG. 6 shows a side view of two track links of the track of FIG. 1, hinged together and observed in a direction parallel to the rotation axes of their hinging pins;

FIG. 7 shows a cross section of a first known solution for preventing or limiting pin walking in a crawler track;

FIG. 8 shows a cross section of a second known solution for preventing or limiting pin walking in a crawler track.

### DETAILED DESCRIPTION

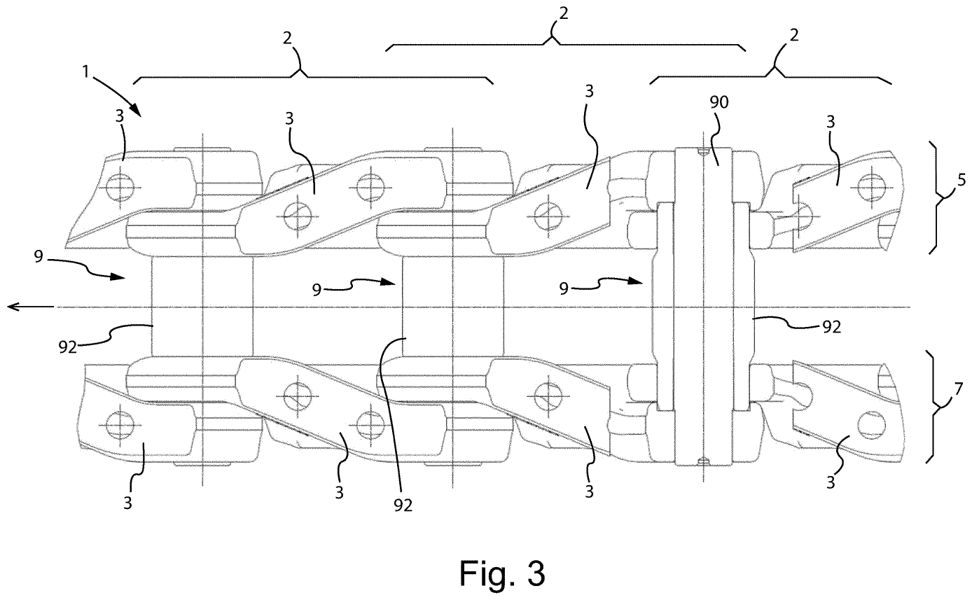

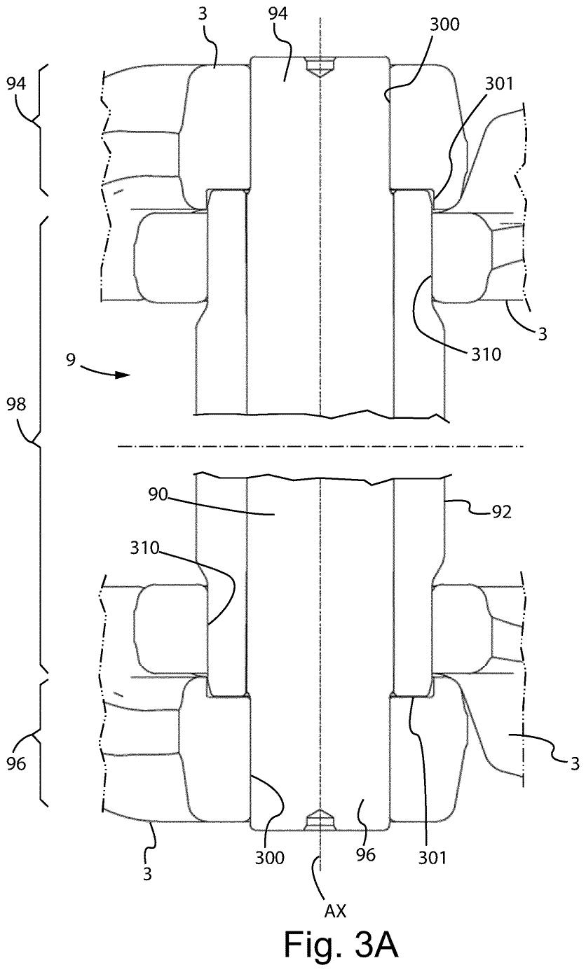

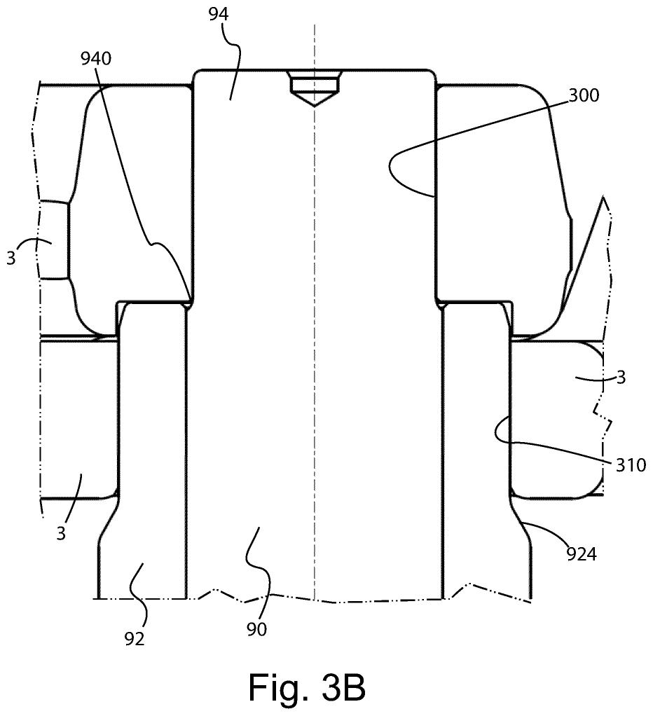

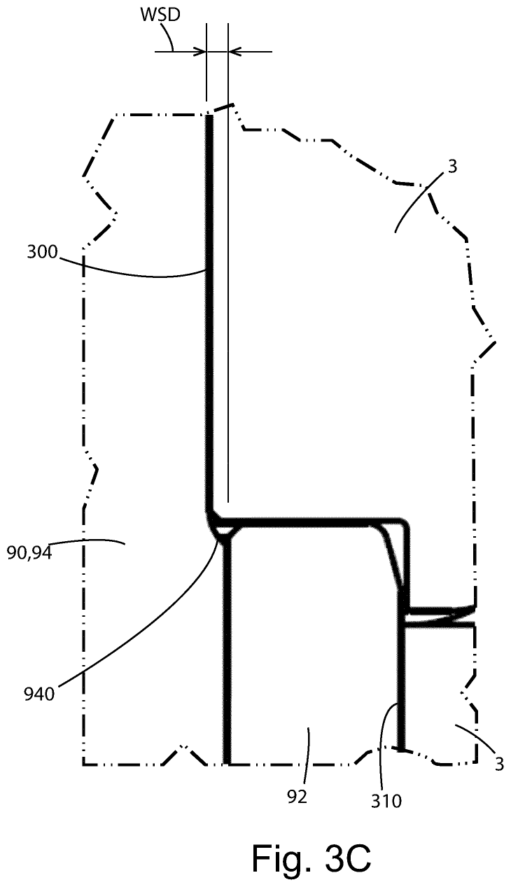

FIGS. 3-6 relate to a particular embodiment of a track according to the present invention.

Such track, referred to as with the overall reference numeral 1, can be part of tracked vehicles such as crawlers, tanks, bulldozers, and other earthmoving machines and heavy equipment to be used for example in mining, heavy constructions, demolition and waste disposal.

The track 1 can be an endless track, that is it can form a flexible ring closed on itself.

Such tracked vehicles can be provided with one or more wheels arranged for rolling on a track 1 when these vehicles travel or more generally move.

The track 1 comprises a plurality of track modules 2 connected and articulated together so as to form a track chain.

Each track module 2 comprises a first and a second track link 3 arranged side by side one to another and a plurality of pin assemblies 9 connecting the first to the second track link 3.

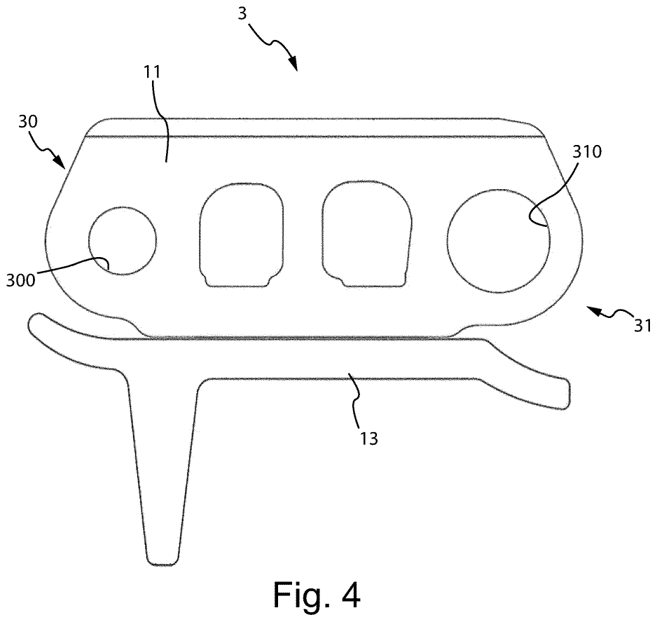

Each track link 3 can comprise a link body 11 and a track shoe 13, fastened to the link body (FIG. 4).

Each link body 11 or more generally track link 3 forms a first 30 and a second end 31 substantially arranged at opposite sides of the link body 11 or track link 3 respectively; in this regard the link bodies 11 and/or track links 3 can have a substantially oblong shape (FIG. 4).

The first end 30 forms a pin coupling seat 300. The second end 31 forms a bushing coupling seat 310. Each of said opposite ends 30, 31 can be shaped as circular cross section bores.

Each pin assembly 9 comprises a hinging pin 90.

Each hinging pin 90 terminates in two coupling pin ends 94, 96 arranged at opposite positions one to another relative to the middle section of the hinging pin 90.

The coupling pin ends 94, 96 are preferably coaxial one to another and with the longitudinal axis AX of the hinging pin 90.

Each coupling pin end 94, 96 and/or the enlarged central section 98 of the pin 90 can have for example a substantially cylindrical shape.

One or more of the coupling pin end 94, 96 or the enlarged central section 98 or the whole hinging pin 90 can have substantially circular cross sections.

Each coupling pin end 94, 96 of said hinging pins 90 fits—for example because it has been press-fitted, drive-fitted or forced-fitted—in a respective pin coupling seat 300 of a track link 3 of an adjacent track module 2.

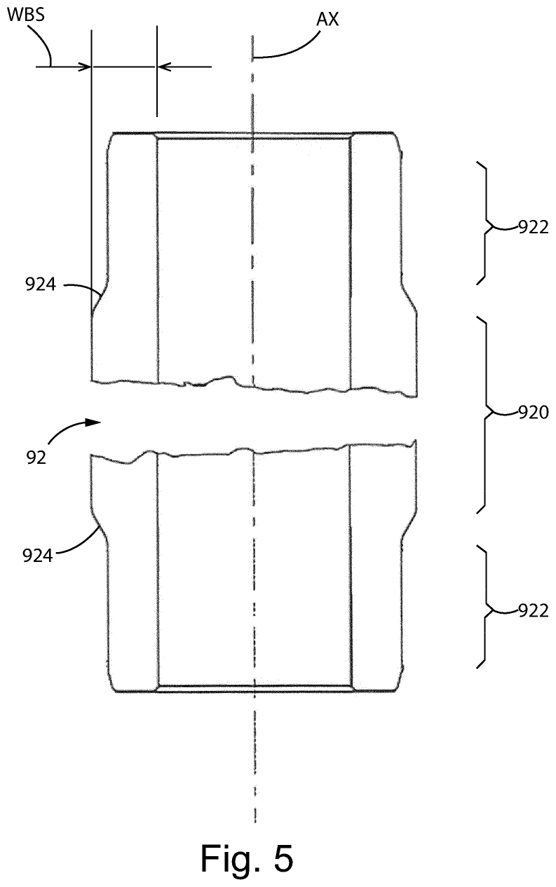

Each main pin bushing 92 terminates in two coupling bushing ends 922 arranged at opposite axial positions one to another (FIG. 5).

Each coupling bushing end 922 fits—for example it can be press-fitted, drive-fitted or forced-fitted—in a respective bushing coupling seat 310 of a track link 3 of the track module 2 of which the considered main pin bushing 92 is part.

The main pin bushing 92 has a substantially tubular shape, extends over at least 0.4 times of the overall axial length of the hinging pin 90 and contains at least part of the hinging pin 90 so as to connect and articulate the track module 2, of which the pin assembly 9 is part, to an adjacent track module 2.

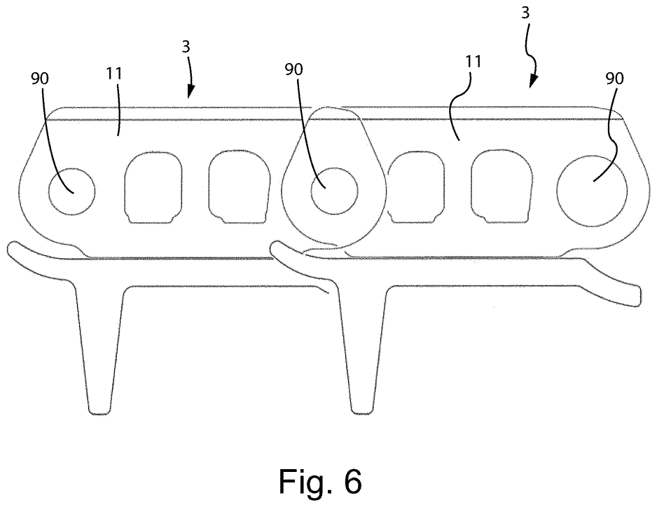

For example, as shown in FIG. 6, each pin assembly 9 allows two adjacent track links 3 of track modules 2 to rotate one relative to another around the longitudinal axis AX of a common hinging pin 90 (FIG. 6).

The main pin bushing 92 extends over a fraction of the overall axial length of the hinging pin 90 preferably comprised between 0.4-0.8 times, between 0.5-0.7 times or between 0.6-0.7 times the overall axial length of the hinging pin 90.

Preferably the main pin bushing 92 extends over at least half or 0.6 times the overall axial length of the hinging pin 90.

Preferably the main pin bushing 92 contains at least the enlarged central section 98 of its respective hinging pin 90.

In an aspect of the present invention, each coupling pin end 94, 96 of each hinging pin is delimited by a shoulder 940 resting or however arranged for resting against one of said respective adjacent/subsequent track links 3, for example against the edge of a respective pin coupling seat 300, so as to prevent or limit the axial displacement of said hinging pins 90 relative to the track links 3 hinged by said pin 90 (FIGS. 3B, 3C).

The shoulder 940 has a radial width WSD preferably comprised between 0.1-1 millimetres, more preferably comprised between 0.3-0.8 millimetres, 0.4-0.7 millimetres, 0.4-0.6 millimetres and for example of about 0.5 millimetres.

Advantageously the edge of the pin coupling seat 300, against which the shoulder 940 can rest, is substantially not chamfered or has a circumferential chamfer the radial width or axial depth of which is advantageously equal to or smaller than the radial width WSD of the shoulder 940.

Analogously, if the pin coupling seat 300, against which the shoulder 940 can rest, has a rounded or smooth edge, the average or maximum radius of curvature of the axial cross sections of the edge are advantageously equal to or smaller than the radial width WSD of the shoulder 940.

These arrangements of the edge of the pin coupling seat 300 limit the maximum axial displacement of the pin 90 allowed by shoulder 940 when the press-fit connection of the pin 90 in the seat 300 loosens (e.g. due to wear).

The shoulders 940 can be for example obtained by turning.

The turning operation for making the shoulder 940 can be performed at the same time when the hinging pin 90 is placed in a turning machine for producing the hinging pin 90. No extra manufacturing step or turning tool is required.

Each of said hinging pins 90 forms an enlarged central section 98 arranged axially between said two coupling pin ends 94, 96.

Each of said shoulders 940 is axially interposed between a respective coupling pin end 94, 96 and the central section 98.

The enlarged central section 98 can extend over a fraction comprised for example between 0.4-0.95 times between 0.4-0.9 times, between 0.4-0.8 times, between 0.5-0.7 times or between 0.6-0.7 times the overall axial length of the hinging pin 90.

Advantageously the enlarged central section 98 has substantially the same overall length of the main pin bushing 92.

Preferably the central section 98 has an average or maximum diameter substantially greater than the average or maximum diameter, respectively, of the coupling pin ends 94, 96 of the same hinging pin 90.

Preferably the average or maximum diameter of the central section 98 is comprised between 20-200 millimetres, or between 20-150 millimetres, 30-70 millimetres, 70-110 millimetres or 110-150 millimetres.

Preferably the average or maximum diameter of the coupling pin ends 94, 96 is comprised between 20-200 millimetres, or between 20-150 millimetres, 30-70 millimetres, 70-110 millimetres or 110-150 millimetres.

The central section 98 and the coupling pin ends 94, 96 can have substantially constant diameters over their respective axial lengths.

One or more of said hinging pins 90 have an overall axial length preferably comprised between 80-800 millimetres, between 100-200 millimetres, between 200-300 millimetre, between 300-400 millimetres, between 400-500 millimetres or between 500-600 millimetres.

The wall of the main pin bushing 92 can have a maximum radial thickness WBS for example comprised between 5-50 millimetres and a minimum radial thickness comprised for example between 5-20 millimetres.

Advantageously the main pin bushing 92 can have an enlarged middle section 920 and two coupling bushing ends 922 having a smaller average-or maximum diameter than the middle section.

The enlarged middle section 920 is conceived for engaging the drive sprocket (not shown) driving the endless track and causing the tracked vehicle to proceed and for withstanding the wear caused by the drive sprocket during operation.

Each coupling bushing end 922 is separated from the middle section by a shoulder 924.

Such shoulder 924 can possibly rest against the edge of a respective larger coupling seat 310 in the track link 3 (FIG. 3A).

Preferably the axial end face of each coupling bushing end 922 butts in an axial direction against the bottom of a shallow recess 301 forming one of the edges of a smaller coupling seat 300.

In the assembled track 1 each hinging pin 90 is substantially and preferably coaxial with its respective main pin bushing 92 and the bores or other pin coupling seats 300 in which the ends 94, 96 of the respective pin 90 are inserted and bushing coupling seats 310, and the longitudinal axes AX of the hinging pins 90 preferably are substantially perpendicular or more generally transversal to the direction of forward motion of the track 1 and/or to the ideal planes in which the two track links 3 of the respective track module 2 overall lie.

The hinging pins 90, the main pin bushings 92, the link bodies 11, the shoes 13 and other parts of the track 1 are preferably made of steel or other metallic material.

A possible example of operation of the track 1 is now described.

As already explained, in normal operating conditions the coupling pin ends 94, 96 of each hinging pin 90 are integral with—for example because they have been press-fitted, drive fitted or forced-fitted—their respective pin coupling seats 300 made in two track links 3 of a track module 2 adjacent to the track module of which said hinging pin 90 is part.

The coupling bushing ends 922 of each main pin bushing 92 are integral with—for example because they have been press-fitted, drive fitted or forced-fitted—their respective bushing coupling seats 310 made in two track links 3 of the track module 2 of which said main pin bushing 92 is part.

As already explained the hinging pin 90 axially—or however longitudinally—extends through and beyond its respective main pin bushing 92 and, since it can rotate relative to the bushing 92 it hinges the track module 2 of which is part and the adjacent track module 2 allowing them to rotate one relative to another around the pin axis AX.

In normal operating conditions the axial displacement, along the pin axis AX, of the two adjacent track modules 2 one relative to another can be for example a few tenth of millimetres, for example 0.1 millimetres, 0.2 millimetres or 0.4 millimetres.

In anomalous operating conditions the two coupling pin ends 94, 96 of a hinging pin 90 can loosen and can move relative to and even get disconnected from their respective coupling seats 300.

At first the hinging pin 90 can start an axial movement but then its shoulder 940 rests very soon—for example after an axial displacement of a few tenths of millimetres such as 0.1-0.8 millimetres—against the edge of one pin coupling seat 300 in which the coupling pin ends 94 or 96 is still inserted in, stopping very soon the pin-walking; the contact surface of the two coupling pin ends 94, 96 with their respective pin coupling seats 300 is just negligibly reduced without compromising the operation, resistance and operating life of the track 1.

The track 1 can keep operating correctly still a relatively long time until the disconnection of the pin 90 from the seats 300 is detected and repaired.

The shoulders 940 are a very simple and strong stops able to withstand very strong axial thrusts.

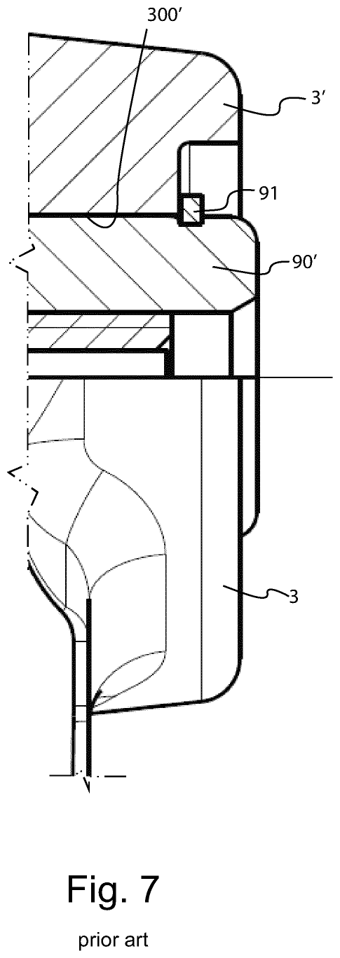

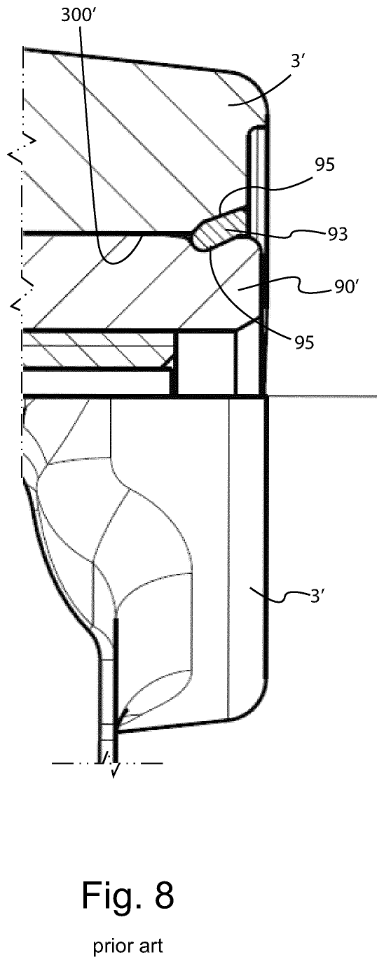

Unlike the known arrangements of FIGS. 7, 8 the shoulders 940 can be obtained through simple turning with the same tool used for turning the sides of the pins 90; they do not need to be made with a special turning tool; nor do they require additional parts to be assembled in the endless track.

Furthermore reducing or avoiding pin walking through the shoulder 940 is in no way affected by wear of the endless track against the rolls.

The previous teachings allow the axial displacement of the pin 90 to be reliably kept equal or smaller than the width WSD of the shoulder 940 in case of pin walking, for example equal to or less than 0.1 -1 millimetres.

These advantages are particularly appreciable in heavy duty applications such as in mining, heavy constructions, demolition and waste disposal, and in general in earthmoving machines, heavy equipment and forestry.

The embodiments previously described can be modified in several ways without departing from the scope of the present invention.

All constructional details can be replaced with technically equivalent elements.

A wording such as “A comprises B, C, D” or “A is made up of B, C, D” is to be understood as encompassing and disclosing the particular case of “A consists of B, C, D”.

1.-12. (canceled)

13. A track, comprising:
a plurality of track modules connected and articulated together so as to form a track chain;
wherein each track module comprises a first and a second track link arranged side by side one to another and a plurality of pin assemblies connecting the first to the second track link;
wherein each track link forms a first and a second opposite end;
wherein said first end forms a pin coupling seat;
wherein said second end forms a bushing coupling seat;
wherein each pin assembly comprises a hinging pin and a main pin bushing;
wherein each hinging pin terminates in two coupling pin ends arranged at opposite positions one to another;
wherein each coupling pin end of said hinging pins fits in a respective pin coupling seat of a track link of an adjacent track module;
wherein each main pin bushing terminates in two coupling bushing ends arranged at opposite axial positions one to another;
wherein each coupling bushing end of said main pin bushing fits in a respective bushing coupling seat of a track link of the track module of which said main pin bushing is part;
wherein the main pin bushing has a substantially tubular shape, extends over at least 0.4 times the axial length of the hinging pin and contains at least part of the hinging pin so as to connect and articulate the track module of which the pin assembly is part to an adjacent track module;
wherein each coupling pin end is delimited by a shoulder resting or however arranged for resting against a respective track link of an adjacent track module so as to prevent or limit the axial displacement of said hinging pins relative to the track links of the adjacent track module.

14. The track according to claim 13, wherein said shoulder has a radial width comprised between 0.1-1 millimetres.

15. The track according to claim 14, wherein said shoulder has a radial width comprised between 0.3-0.8 millimetres.

16. The track according to claim 13, wherein the edge of the pin coupling seat, against which the shoulder can rest, is substantially not chamfered or has a circumferential chamfer the radial width or axial depth of which is advantageously equal to or smaller than the radial width of the shoulder.

17. The track according to claim 13, wherein the pin coupling seat, against which the shoulder can rest, has a substantially rounded or smooth edge, and the average or maximum radius of curvature of the axial cross sections of said edge is advantageously equal to or smaller than the radial width of the shoulder.

18. The track according to claim 13, wherein each of said hinging pins forms an enlarged central section arranged, with reference to the axis of the hinging pin, between said two coupling pin ends, each of said shoulder is axially interposed between a respective coupling pin end and the enlarged central section, the enlarged central section has an average or maximum diameter substantially greater than the average or maximum diameter, respectively, of the coupling pin ends of the same hinging pin.

19. The track according to claim 18, wherein the average or maximum diameter of the enlarged central section and/or of the coupling pin ends is comprised between 20-200 millimetres or 30-150 millimetres.

20. The track according to claim 13, wherein one or more of said hinging pins have an overall axial length comprised between 80-800 millimetres or 100-600 millimetres.

21. The track according to claim 13, wherein each coupling pin end of said hinging pins is press-fitted, drive-fitted or forced-fitted in a respective pin coupling seat of a track link of an adjacent track module.

22. The track according to claim 13, wherein each of said hinging pins forms an enlarged central section arranged axially between said two coupling pin ends.

23. The track according to claim 22, wherein one or both coupling pin ends and/or the enlarged central section of the hinging pin has a substantially cylindrical shape.

24. A tracked vehicle comprising one or more tracks according to claim 13.
